(19) United States
(12) Patent Application Publication
(10) Pub. No.: US 2009/0164818 A1
(43) Pub. Date: Jun. 25, 2009

(54) ACTIVITY WINDOW NOTIFICATION PROTOCOL

(76) Inventors: Seh W. Kwa, San Jose, CA (US); Neil Songer, Santa Clara, CA (US); James J. Walsh, Santa Clara, CA (US)

Correspondence Address: Kirton & McConkie Attorneys at Law, c/o Intellevate, LLC, P.O. Box 52050, Minneapolis, MN, 55402, US

(21) Appl. No.: 11/960,417

(22) Filed: Dec. 19, 2007

(51) Int. Cl. G06F 1/32

(52) U.S. Cl. 713/323

(57) ABSTRACT

Power management protocols for maximizing energy efficiency in power usage by mobile devices are described in this application. The power management protocols may allow for at least two power states by a CPU—active state, and inactive state. The active state corresponds to an active window when the mobile device is functional at full capacity and using the full clock speed frequency. The inactive state and opportunistic flush and fill states may be maximized by coordinating the activity of the CPU and other devices associated with a mobile device such as a bus, memory, graphics controller, hard drive, etc. By coordinating the critical functions of devices and CPU to occur during the active window, and delaying non-critical functions until an active window, the inactive and off states may be maximized, resulting in power savings and efficiency. Other embodiments are also described in this application.

### FIELD

This application relates generally to power management protocols in computer systems. In particular, this application relates to improved activity window management and notification protocol for various components in a computer system.

### BACKGROUND

Energy management efficiency is desirable in computer systems, particularly computer systems relying on battery power. As a result of the desirability of low power states in electronic components, PME# on PCI or Wake# on PCI Express are mechanisms designed to support a device signaling an exit from deep system or device low power state. Powering down electronic components, including CPU's, may lead to reduced performance of a computer due to the time lag incurred when powering up the electronic component to perform required functions. As computer devices have become bus-master oriented in controlling and connecting electronic components, many interconnects and buses play a limited or no role in modifying traffic behavior between electronic components. Thus, some electronic components may be in a low power state when an associated component is in an active state, without organized management of the power states of each electronic component. In some computer systems, the protocols determining when electronic components may be in low power state may vary between electronic components, such that two components not in use may have dissimilar power states. Similarly, during low power states, different components may perform certain functions, such as a check to verify that the component is not needed, or non-critical data purge or storage, including relieving back pressure in buffering, at different times, requiring other components to function in response at a potentially inefficient time.

### BRIEF DESCRIPTION OF THE DRAWINGS

The following description can be better understood in light of Figures, in which:

FIG. 1 is a graphic illustration of the operation of an exemplary embodiment;

FIG. 2 illustrates an operational grid of an exemplary embodiment; and

FIG. 3 illustrates an operational grid of an exemplary embodiment.

Together with the following description, the Figures demonstrate and explain the principles of the apparatus and methods described herein. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the methods, systems and devices described herein can be implemented and used without employing these specific details. Indeed, the devices, systems, and associated methods can be placed into practice by modifying the systems and methods and can be used in conjunction with any apparatus and techniques conventionally used in the industry. For example, while the description below focuses on power management for Intel® CPU's, chipsets and programming for mobile electronics devices such as laptop computers, the systems and methods can be equally applied with other electronic devices. Indeed, the systems and methods may be implemented in many applications such as desktop computers, televisions, mobile video players, mobile audio devices, or any other electronic device that may benefit from power management. Additionally, although this disclosure focuses on how to communicate and coordinate three types of windowing and likely overlaying onto existing PCI Express sideband Wake#, it is extensible to any other communication means such as dedicated broadcast messages or control signals.

Electronic components in a computer system, such as the CPU, graphics and memory control hub, memory, graphics processors, disk drives, etc., may consume energy even when not being actively used. Microprocessors, chipsets and other devices maintain high performance by remaining active to respond quickly to requests for data processing, transfer, retrieval, or storage. However, in battery powered devices such as laptop computers, power conservation and management are important to prolong battery life. As such, power protocols often allow electronic components to be in a low power or “deep sleep” state while not in active use. The low power state may be short or long periods of time. For example, a hard disk storage drive may be in a low power state while a program is being used that does not access information stored on the drive.

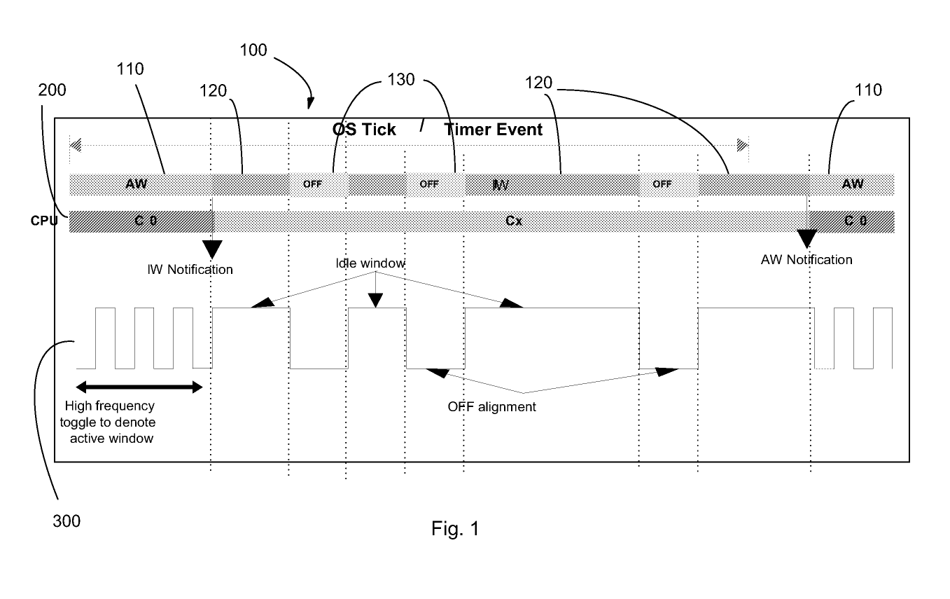

Embodiments of the power management protocols and methods can have any configuration consistent with the operations described in herein. The operation of some embodiments of a power management protocol is graphically illustrated in FIG. 1. Power management protocol 100 may be implemented on a computer having a CPU, bus controller, and associated electronic devices such as graphics controllers, memory, hard drives, printers, video displays, input devices, external storage devices, etc. FIG. 1 illustrates functioning of a CPU utilizing power management protocol 100. Section 200 illustrates the activity state of the CPU. Section 300 illustrates digital cycling indicating activity frequency of the CPU.

As shown in section 200, in some embodiments, the CPU may have at least two power states, active state 110, inactive state 120, and, within inactive state 120, an opportunistic flush and fill (“OFF”) state 130. Active state 110 may indicate full power and activity of the CPU in an active window for processing data and controlling a computer system. Inactive state 120, or inactive window, may indicate a low power mode and waiting for indications or input to resume active state 110. Inactive states 120 and OFF states 130 may correspond to when there is no meaningful processing to be done by the CPU. Similarly, non-critical functions may correspond to those functions that do not require immediate processing for continued functioning of the computer or any programs then running on the computer.

OFF state 130 may indicate no power usage. As shown in section 300, during active state 110, the clock frequency of the CPU may be high. In some embodiments, the clock speed during active state 110 may be less than about 20 μsec. More particularly, in some embodiments the clock speed during active state 110 may be about 2 μsec.

In contrast, during inactive state 120, the clock speed of the CPU may be inconsistent and less than the clock speed during active state 110. For example, in some embodiments, the clock speed during inactive state 120 may be more than about 20 μsec. More particularly, in some embodiments the clock speed during inactive state 120 may be between 20 and 200 μsec. Because of the low power state during inactive state 120, the off power states 130 during inactive state 120 may not represent CPU clock processing, but rather off states 130 represent very low power state, saving power. The low clock speed of inactive state 120 allows off states 130 to be extended, allowing energy savings.

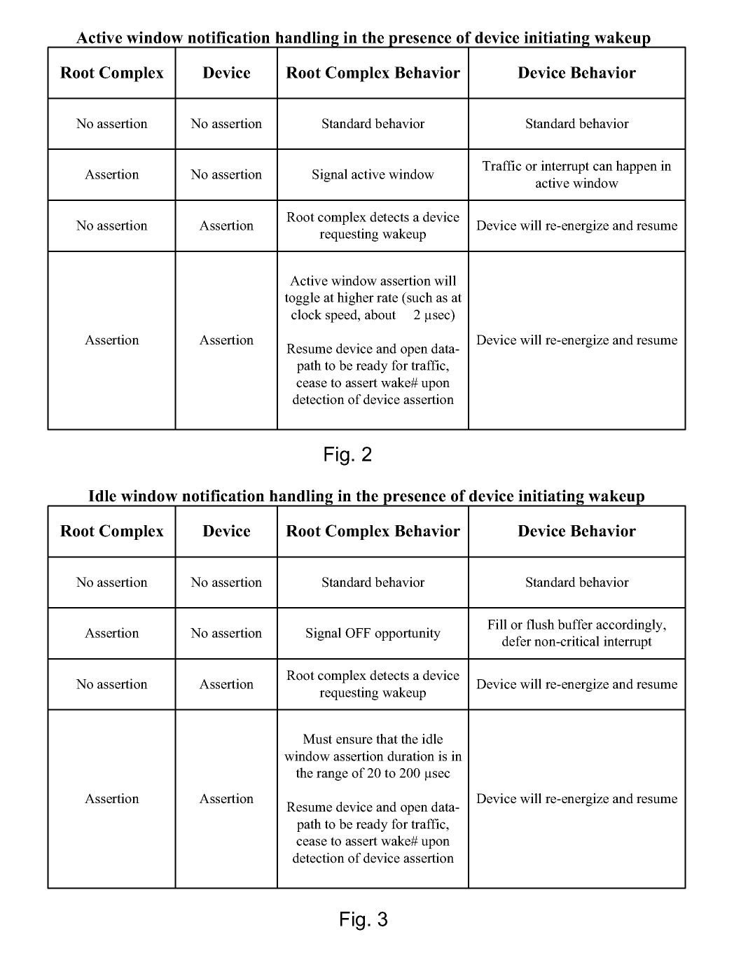

FIG. 2 illustrates conditions by which active state 110 or the active window functions in response to requests by devices for wakeup or for data processing. Similarly, FIG. 3 illustrates conditions by which inactive state 120 or the inactive window functions in response to requests by devices for wakeup or for data processing. FIG. 2 may illustrate normal functioning of the CPU in active state 110 in responding to assertions by devices or by the root complex. As shown in FIG. 3, when no device requests wakeup to the root complex, but some processing is indicated in the root complex, the devices are signaled to perform self-contained functions such as and opportunistic flush and fill 130 window for devices to relieve back pressure in buffering, whether it is data producing or consuming. Additionally, devices may also be signaled to defer any non-critical request for processing by the CPU to such time that the CPU is in active state 110. During this period, the CPU may assume OFF state 130. If a device then requests wakeup of the CPU, the request may be considered to be critical in the root complex, and the device and the CPU may then be placed into active state 110.

Thus, power consumption is reduced when activity within the system is aligned, maximizing times when the system is idle, which in turn allows best use of reduced power states. The conditions illustrated in FIGS. 2 and 3 may afford capabilities to steer non-critical interrupts and traffic to the CPU during active state 110 to maximize low power state residency for CPU and memory subsystem.

One advantage of some embodiments may be to avoid or minimize the dependency of high frequency clocks during inactive states 120 and off states 130 by using a signaling scheme that does not require high frequency clocks to stay running during inactive states 120 and off states 130. This may allow the computer to maximize the opportunity to shutdown high frequency components during idleness in order to save power. In classical CMOS power analysis this may be a valid approach because of dynamic power being proportional to frequency.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A method of managing power in a computer, comprising:
providing a CPU, wherein the CPU has at least two operational states, including:
an active state, wherein the CPU performs critical functions during the active state; and
an inactive state, wherein the CPU requires less power than when in the active state;
notifying at least one device attached to the CPU of the operational state of the CPU; and
coordinating activity of the at least one device and the CPU based on the operational state of the CPU.

2. The method of claim 1, wherein the coordinating activity of the at least one device and the CPU is configured to perform non-critical functions only when the CPU is in the active state.

3. The method of claim 1, wherein the at least one device is configured to signal the CPU to be in the active state when a critical function is required.

4. The method of claim 1, wherein the inactive state is configured to operate with a reduced clock speed than the clock speed of the active state.

5. The method of claim 4, wherein the reduced clock speed is between about one cycle per 20 μsec and about one cycle per 200 μsec.

6. The method of claim 4, wherein the clock speed of the active state is less than about 20 μsec.

7. The method of claim 1, wherein the CPU is configured to alternate between the inactive state and an opportunistic flush and fill state when not in the active state.

8. The method of claim 1, wherein the computer is a mobile device configured to run on battery power.

9. The method of claim 1, wherein the at least one device is a bus controller device.

10. A power management system for a computer, comprising:
a CPU;
a plurality of devices associated with the CPU;
a bus configured to facilitate operable connectivity between the plurality of devices and the CPU, wherein the CPU is configured to have at least two power states when the computer is operating, the two power states including:
an active state, the active state being configured such that all critical functions are performed during active state; and
an inactive state, the inactive state being configured such that all non-critical functions are delayed during the inactive state; and
wherein the CPU, the plurality of devices, and the bus are configured to coordinate activities such that the amount of time of the CPU in active state is minimized.

11. The system of claim 10, wherein the computer is a mobile device configured to run on battery power.

12. The system of claim 10, wherein the coordinated activities include only placing the CPU in the active state for critical functions.

13. The system of claim 10, wherein the bus is one of a PCI or PCI Express bus.

14. The system of claim 10, wherein the inactive state is configured to operate with a reduced clock speed than the clock speed of the active state.

15. The system of claim 14, wherein the reduced clock speed is between about 20 μsec and about 200 μsec, and wherein the clock speed of the active state is less than about 20 μsec.
